(19) United States
(12) Patent Application Publication
(10) Pub. No.: US 2019/0142175 A1
(43) Pub. Date: May 16, 2019

(54) ADAPTABLE BED SYSTEM

(71) Applicant: UNITED FURNITURE INDUSTRIES, INC., TUPELO, MS (US)

(72) Inventor: TONY CANTRELL, St. Charles, IL (US)

(73) Assignee: UNITED FURNITURE INDUSTRIES, INC., TUPELO, MS (US)

(21) Appl. No.: 15/813,650

(22) Filed: Nov. 15, 2017

(51) Int. Cl. A47C 19/20; F16B 12/36

(52) U.S. Cl. CPC A47C 19/202; F16B 2012/2018; F16B 12/36

(57) ABSTRACT

An adaptable bed system with improved connection mechanisms comprising a bed frame, legs and connection members, wherein the connection members further comprise Allen bolts, dowels, pins and nuts, and can be assembled and tightened using standard tools, such as Allen keys, thus decreasing cost and time required for assembly of the bed system.

### FIELD OF THE INVENTION

The presently disclosed subject matter relates to a bed system, and more particularly to an adjustable bed with improved connection mechanisms and the method thereof.

### BACKGROUND OF THE INVENTION

Beds and bed systems are used by most individuals in a variety of residential settings, such as single family homes, apartments, dorm rooms, and even in commercial and military settings where sleep is required by employees. The spatial requirements differ greatly in each setting making it necessary to utilize different configurations of bed systems to accommodate such requirements and provide convenience to users. Convertible bed systems with one or more beds which can be assembled in multiple configurations to accommodate different spaces and lifestyles are known in the art.

The current convertible bed systems require custom connection pieces to assemble and reassemble the bed systems in the multiple configurations. These custom connection pieces are assembled using custom and/or non-standard tools which take excessive amounts of time to learn to use and subsequently use and add cost to the adaptable beds. Thus, a need exists for a bed system with multiple configurations which can be assembled using standard connection mechanisms and tools to decrease assembly time and cost to users.

### SUMMARY OF THE INVENTION

Current convertible bed systems connect via custom connection pieces requiring custom or non-standard tools for assembly and increase costs paid and time spent by users. I disclose herein an improved adaptable bed system using standard connection mechanisms and tools for assembly to increase efficiency of assembly, comprising a bed frame 11, legs 12 and connection members 13, wherein the connection members further comprise Allen bolts, dowels, pins and nuts tightened by Allen keys and other standard tools, thus decreasing cost and time required for users to configure the bed system. I also disclose a method of assembly and reassembly of an adaptable bed system using improved connection mechanisms to increase stability of the system and user experience.

### BRIEF DESCRIPTION OF THE DRAWINGS

Further advantages of the invention will become apparent by reference to the detailed description of preferred embodiments when considered in conjunction with the drawings:

FIG. 1 depicts a perspective view of an adaptable bed system.

FIG. 2 a perspective view of an Allen bolt and camlock exploded.

FIG. 3 depicts a perspective view of Allen bolt and camlock assembled in a frame.

FIG. 4 depicts a perspective view of a pin, center nut, and arrow nut exploded.

FIG. 5 depicts a perspective view of a pin, center nut, and arrow nut assembled in a frame.

FIG. 6 depicts a perspective view of an Allen bolt and dowel connection in a frame.

### DETAILED DESCRIPTION

The following detailed description is presented to enable any person skilled in the art to make and use the invention. For purposes of explanation, specific details are set forth to provide a thorough understanding of the present invention. However, it will be apparent to one skilled in the art that these specific details are not required to practice the invention. Descriptions of specific applications are provided only as representative examples. Various modifications to the preferred embodiments will be readily apparent to one skilled in the art, and the general principles defined herein may be applied to other embodiments and applications without departing from the scope of the invention. The present invention is not intended to be limited to the embodiments shown, but is to be accorded the widest possible scope consistent with the principles and features disclosed herein.

Bed systems available on the market require custom connection pieces to assemble and reassemble the bed systems in multiple configurations. These connection pieces are assembled with custom and/or non-standard tools which require excessive time to configure and assemble the bed components and cost to acquire the tools. The presently disclosed adaptable bed system can be assembled in multiple configurations using standard connection mechanisms and commercially available off the shelf tools to decrease assembly time and cost to users.

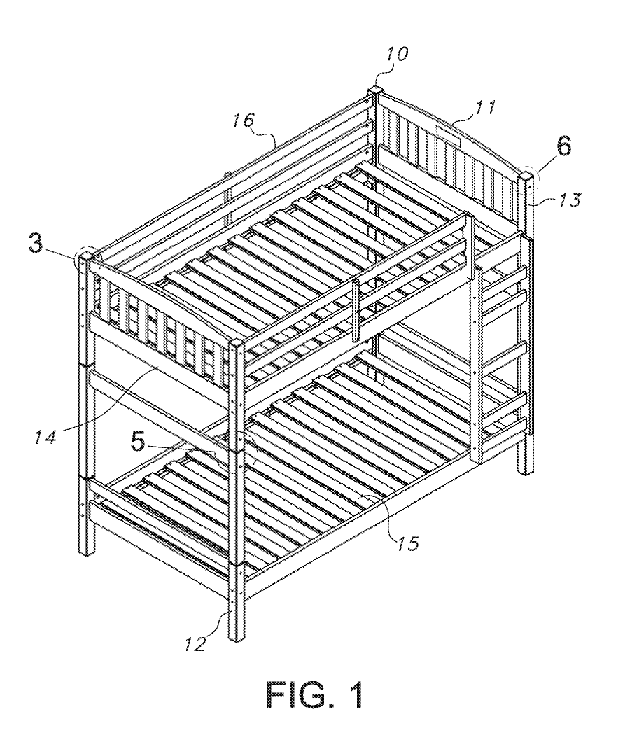

As shown in FIG. 1, the adaptable bed system 10 can be configured and reconfigured to at least six different configurations. By assembling the components included in each adaptable bed system 1, the user can configure at least the following beds: a twin-twin bunk bed, a junior loft bed, a twin bed, a low profile twin bed, a toddler bed, and a daybed.

The adaptable bed system 10 comprises a bed frame 11, legs 12 and connection members 13. The bed frame 11 includes various components that may be interconnected in numerous configurations. The bed frame 11 components include, but are not limited to, bed ends 14, slats 15, and side rails 16 for interconnection of the bed frame 11 and legs 12. Slats 15 for supporting a mattress are attached to side rails 16 to support the bed frame 11. The legs 12 come in both standard and elevated heights depending on the desired elevation of the 11 bed frame(s).

While these standard connection mechanisms are provided with the adaptable bed system 1 when purchased, these parts and corresponding assembly tools are commercially available off the shelf of any hardware store. Further, there is no training or advanced level of skill necessary to use the tools to assemble the connection mechanisms.

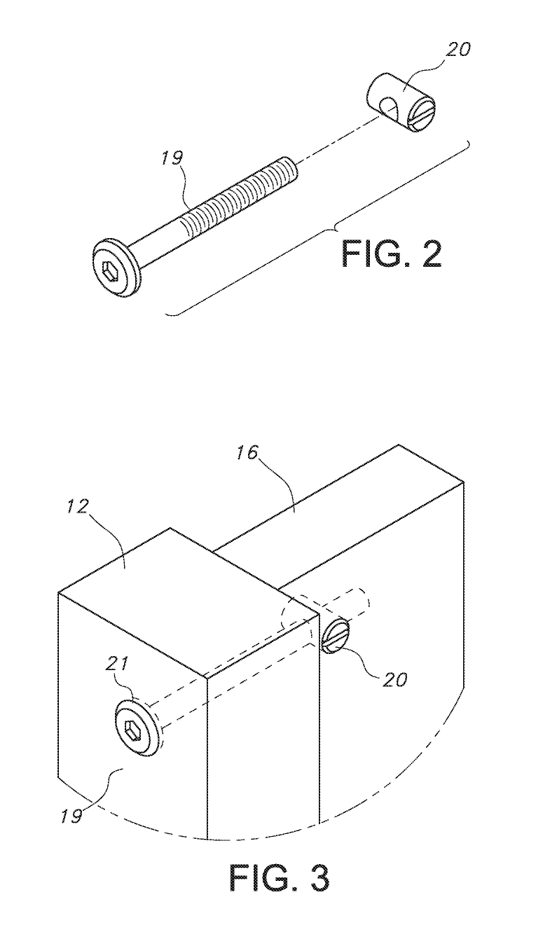

In an embodiment of the adaptable bed system, horizontal support of the adaptable bed system 1 is provided by Allen bolts 19 and camlocks 20, as shown in FIG. 2. In this embodiment, the bed ends 14 and side rails 16 are attached to legs 12 via a camlock 19, with a hole in its first end and configured to receive an Allen bolt 19, inserted through a hole 21 in the side rails 16. An Allen bolt 19 is then inserted orthogonally through a hole 21 in the leg 12 and into the hole in the camlock 20 so that the Allen bolt 19 is perpendicular to the camlock 20, as shown in FIG. 3. The Allen bolt 19 is tightened by an Allen key 19 provided with the adaptable bed system 1 to secure the connection to the camlock. This standard connection mechanism of Allen bolt 19 and camlock 20 also provides horizontal attachment and support for legs 12 of a ladder 23 to side rails 16 and can be used to assemble, among other configurations, the base of a day bed, a low profile twin bed, and a toddler bed with step.

Another potential embodiment for horizontal support includes connecting bed frame 11 components to one another via an Allen bolt 19 and dowel 17 inserted horizontally in each component and parallel to one another. The Allen bolt 19 and dowel 17 connect the bed ends 14 and side rails 16 to the legs 12 to support the bed frame 11. Dowels 17 are first inserted in a hole in the horizontal bed ends 14 and/or side rails 16 prior to being inserted and secured into the vertical leg 12 supports. The Allen bolt 19, if necessary, is then inserted in a second hole in the horizontal bed ends 14 and/or side rails 16 and secured via an Allen key.

Is it also contemplated that Allen bolts without camlocks or dowels can be used to provide horizontal support for the components of the adaptable bed system 1.

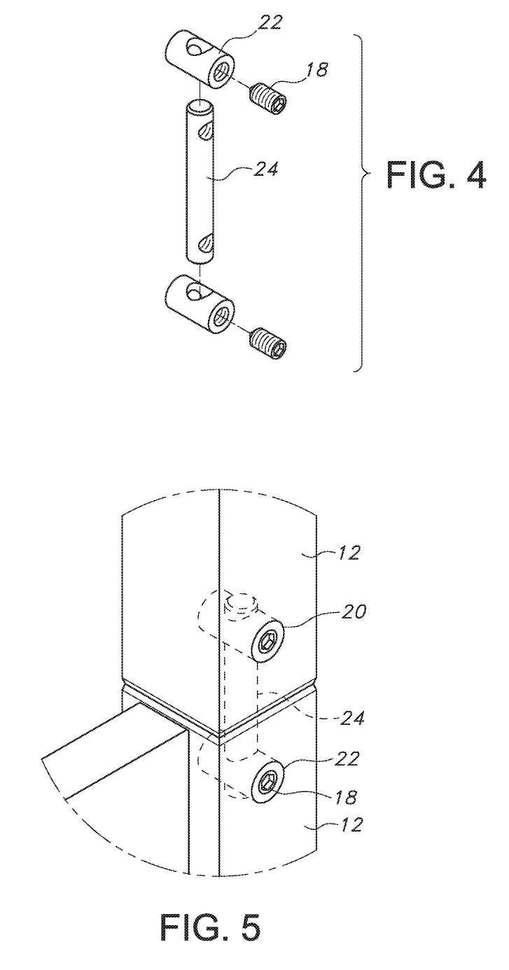

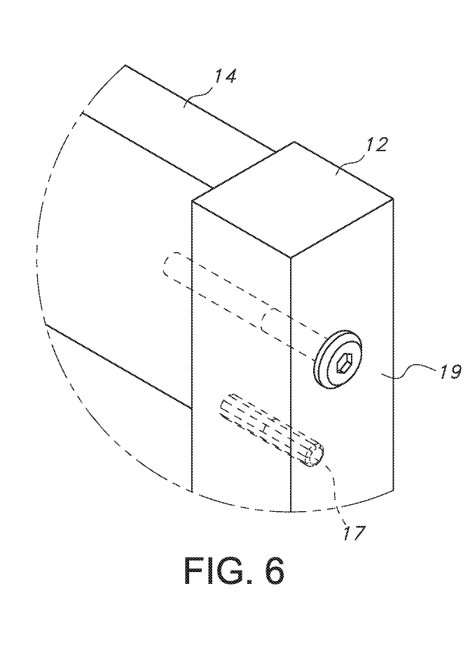

In yet another embodiment, as shown in FIG. 4, a pin 24, center nut 22, and arrow nut 18 provide vertical attachment and support for the adaptable bed system 1 to facilitate the stacking of beds. For instance, legs 12 are stacked on top of and attached to other legs 12 via this vertical support connection mechanism. Specifically, the pin 24, having a first and second hole 20 near each end and equidistant from each other and configured to orthogonally receive two center nuts 22, is placed in a hole in the first leg 12 and hole in the second leg 12, as shown in FIG. 5. The pin 24 secures attachment of the two legs 12 by receiving two center nuts 22 configured to axially receive two arrow nuts 18, which are inserted in each hole 20 of the pin 24 after the pin 24 is inserted vertically to connect the first and second leg 12. Two arrow nuts 18 are inserted into and secure each center nut 22. Similar to the horizontal connection mechanisms discussed above, a standard Allen key tightens the arrow nuts 18 in each center nut 22 of the pin 24. The standard vertical attachment connection mechanism, which attaches a first leg 12 to a second leg 12 can be used to assemble, among other configurations, a twin-twin bunk bed and junior loft bed.

In the preferred embodiment of the vertical attachment connection mechanism, the pin is metal, but any other sturdy material capable of connecting the vertical components is contemplated herein. Additionally, the bed components of the adaptable bed system 1 can be comprised of any sturdy construction material, including but not limited to, metal, wood, particle board, plastic, upholstery, etc., and/or a combination of materials.

Additional embodiments of the adaptable bed system include using standard screws, connectors, and brackets in addition to or in lieu of the above mentioned connection mechanisms.

The terms “comprising,” “including,” and “having,” as used in the claims and specification herein, shall be considered as indicating an open group that may include other elements not specified. The terms “a,” “an,” and the singular forms of words shall be taken to include the plural form of the same words, such that the terms mean that one or more of something is provided. The term “one” or “single” may be used to indicate that one and only one of something is intended. Similarly, other specific integer values, such as “two,” may be used when a specific number of things is intended. The terms “preferably,” “preferred,” “prefer,” “optionally,” “may,” and similar terms are used to indicate that an item, condition or step being referred to is an optional (not required) feature of the invention.

The invention has been described with reference to various specific and preferred embodiments and techniques. However, it should be understood that many variations and modifications may be made while remaining within the spirit and scope of the invention. It will be apparent to one of ordinary skill in the art that methods, devices, device elements, materials, procedures and techniques other than those specifically described herein can be applied to the practice of the invention as broadly disclosed herein without resort to undue experimentation. All art-known functional equivalents of methods, devices, device elements, materials, procedures and techniques described herein are intended to be encompassed by this invention. Whenever a range is disclosed, all subranges and individual values are intended to be encompassed. This invention is not to be limited by the embodiments disclosed, including any shown in the drawings or exemplified in the specification, which are given by way of example and not of limitation.

While the invention has been described with respect to a limited number of embodiments, those skilled in the art, having benefit of this disclosure, will appreciate that other embodiments can be devised which do not depart from the scope of the invention as disclosed herein. Accordingly, the scope of the invention should be limited only by the attached claims.

All references throughout this application, for example patent documents including issued or granted patents or equivalents, patent application publications, and non-patent literature documents or other source material, are hereby incorporated by reference herein in their entireties, as though individually incorporated by reference, to the extent each reference is at least partially not inconsistent with the disclosure in the present application (for example, a reference that is partially inconsistent is incorporated by reference except for the partially inconsistent portion of the reference).

I hereby claim:

1. An adaptable bed system comprising:
a. a bed frame;
b. legs;
c. connection members, wherein the bed frame and legs are connected via the connection members allowing said bed system to be converted to one of a plurality of configurations; and
d. holes in said bed frames and legs configured to receive the connection members.

2. The bed system of claim 1 wherein said one of a plurality of configurations is selected from a list consisting of a twin-twin bunk bed, a junior loft bed, a twin bed, a low profile twin bed, a toddler bed, and a daybed.

3. The bed frame of claim 1 further comprising bed ends, slats, and side rails.

4. The connection members of claim 1 wherein the connection members are Allen bolts and camlocks, wherein said camlock has a hole at a first end for orthogonally receiving the Allen Bolt.

5. The connection members of claim 1 wherein the connection members are Allen bolts and dowels.

6. The connection mechanism of claim 1 wherein the connection members are dowels.

7. The connection members of claim 1 wherein the connection members are a pin, center nut and arrow nut, wherein the pin has holes at both ends for orthogonally accepting two center nuts configured to each receive an arrow nut.

8. The connection members of claim 7 wherein said pin is metal.

9. The connection members of claim 1 wherein the connection members are tightened by an Allen key.

10. A method for connecting an adaptable bed system comprising attaching horizontal bed components to vertical bed components via a camlock and Allen bolt, wherein said camlock has a hole at a first end for orthogonally receiving the Allen Bolt.

11. A method for connecting an adaptable bed system comprising attaching horizontal bed components to vertical bed components via a dowel and Allen bolt.

12. A method for connecting an adaptable bed system comprising attaching bed ends to legs via a camlock and Allen bolt, wherein said camlock has a hole at a first end for orthogonally receiving the Allen Bolt.

13. A method for connecting an adaptable bed system comprising attaching side rails to legs via a camlock and Allen bolt, wherein said camlock has a hole at a first end for orthogonally receiving the Allen Bolt.

14. A method for connecting an adaptable bed system comprising attaching legs of a ladder to side rails via a camlock and Allen bolt, wherein said camlock has a hole at a first end for orthogonally receiving the Allen Bolt.

15. A method for connecting an adaptable bed system comprising attaching vertical bed components via a pin, center nut, and arrow nut, wherein the pin has holes at both ends for orthogonally accepting two center nuts configured to each receive an arrow nut.

16. A method for connecting an adaptable bed system comprising attaching legs of the bed via a pin, center nut, and arrow nut, wherein the pin has two holes at both ends for orthogonally accepting two center nuts configured to each receive an arrow nut.
